(19) United States
(12) Patent Application Publication
(10) Pub. No.: US 2009/0308762 A1
(43) Pub. Date: Dec. 17, 2009

(54) METHOD AND DEVICE FOR TESTING THE TIGHTNESS OF MOISTURE BARRIERS FOR IMPLANTS

(76) Inventor: Hans-Jürgen Tiedtke, Bonn (DE)

Correspondence Address: FOLEY & LARDNER LLP, 777 EAST WISCONSIN AVENUE, MILWAUKEE, WI, 53202-5306, US

(21) Appl. No.: 12/306,633

(22) PCT Filed: Jun. 22, 2007
(86) PCT No.: PCT/EP2007/005542

§ 371 Date: Aug. 28, 2009

(30) Foreign Application Priority Data
Jun. 30, 2006 (DE) 10 2006 030 224.9

(51) Int. Cl. G01N 27/26

(52) U.S. Cl. 205/790.5; 204/400; 204/412

(57) ABSTRACT

Disclosed herein are devices and methods useful for measuring the imperviousness of moisture barriers in implants by means of electrochemical, integrative measurement of small electric charges. Using the devices and methods, the integrity or imperviousness of insulating layers or moisture barriers of implants can be verified more exactly, and the influence of electromagnetic interferences on the measurement can be reduced.

The present invention relates to a device and also to a method for testing the imperviousness of moisture barriers in implants by means of an electrochemical, integrative measurement of small electric charges.

Devices for restoring or for assisting organic sensory functions are known which are implanted in the body of living beings in the form of implants for stimulating living tissue. As a rule, such implants include electric circuits as well as a number of stimulating electrodes, via which electrical stimulating pulses are emitted to the surrounding tissue or to the living cells in order in this way to stimulate the nerves and hence to re-establish or improve the function thereof.

Known implants are frequently an integral part of systems that include electrical or electronic components for sensory or diagnostic purposes, such as, for example, the electrical measurement of bodily functions, blood pressure, blood sugar, or of temperature. By reason of their sensory or diagnostic components, such implants are also designated as passive implants. Stimulation systems may contain components for actoric purposes such as, for example, for electrostimulation, defibrillation, emission of sound or emission of ultrasound. As a rule, such systems include electrical contacts or electrodes that are in direct or indirect contact with the body tissue—such as nerve tissue and muscle tissue, for example—or with body fluids, and by reason of their active components are also designated as active implants.

For a reliable measurement of the bodily functions, it is important that no liquid or ions can penetrate into the implants, into the electrical components or electrodes thereof. As a result of the ingress of liquid and/or ions from outside into the electric circuits or electrodes, in the case of active implants the stimulation of the tissue can be disturbed, or in the case of passive implants the measuring function of the electrical contacts can be impaired. Furthermore, the electronics of the implant can be destroyed by body fluid that has penetrated, for example in consequence of electrolytic processes. The implants, the electrical contacts or electrodes thereof are therefore at least partially surrounded by insulations or moisture barriers, the imperviousness of which in relation to liquids and ions has to be examined prior to their use.

In order to be able to operate the implants in a trouble-free manner, it is extremely important to create highly impervious insulating layers and to encase the electrical contacts or the entire implant in such moisture barriers, for example in “polyimide”, parylenes, silicone by so-called “sapphire coating” or “diamond-like coating”, glass etc. These moisture barriers have to be tested with respect to their imperviousness over long periods of time in their respective embodiment, in order to be able to make a statement about the reliability of the moisture barrier. In this connection it is important to detect reliably even extremely small charge transfers by reason of leakages in the moisture barrier, since these may be a first indication of perforations (pinholes) in the insulation.

Prior charge-measuring processes have, as a rule, been based on electronic processes in which the flow of electric current is integrated with respect to time. In the course of the measurement of extremely small charges—for example, within the femtocoulomb range—the known measuring processes are, however, very sensitive to interspersed electromagnetic interferences, which can lead to large corruptions of the measurement results.

From EP 0 807 246 B1 a charge-measuring process for testing for seal leaks in sealed containers is known in which two electrodes connected to one another via a direct current source and the sealed container are immersed in an electrolyte-bath solution. The electrical conductivity from one electrode to the other is measured, whereby the seal and the sealed container do not leak if no electric current flows from one electrode to the other, and whereby the seal or the sealed container leaks if electric current flows from one electrode to the other.

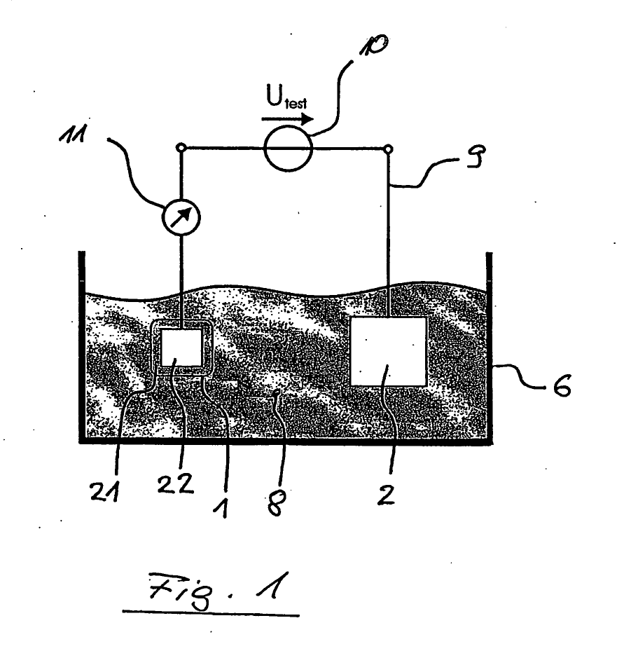

FIG. 1 shows a set-up for implementing an electrochemical charge-measuring process according to the state of the art by direct current measurement. The set-up for implementing a known charge-measuring process includes a bath 6 with an electrolyte liquid 8, in which a first electrode 1 and a second electrode 2 have been immersed. The two electrodes 1, 2 are connected to one another via an electrical lead 9 in which a direct current source 10 and also a charge-measuring instrument (coulometer) 11 are coupled in series. Whereas the metal of the second electrode 2 is in direct contact with the electrolyte liquid 8, the first electrode 1 is surrounded by an insulating layer or by a so-called moisture barrier 21, the imperviousness or integrity of which is to be tested.

The first electrode 1 and the second electrode 2 consist of the same metal, so no electric potential is able to arise between the electrodes 1, 2 by reason of differing materials. If a test voltage Uₜₑₛₜ is applied via the direct current source 10, an electric current is able to flow between the electrodes 1, 2 only when the insulating layer or the moisture barrier 21 around the first electrode 1 is penetrated by electrolyte liquid 8 or ions, such that a contact between the metal of the first electrode 1 and the electrolyte liquid 8 is established, and hence an electric circuit can be formed, with exchange of charge-carriers.

If an electric current flows between the electrodes by reason of a leakage of the insulating layer 21 around the first electrode 1, the electric current that has flowed—or, to be more exact, the quantity of electrons that have flowed—between the electrodes 1, 2, and hence the degree of leakage in the moisture barrier 21, can be measured with the aid of the coulometer 11. In this way the quality of moisture barriers 21 for insulating implants or the electrodes thereof can be checked with respect to their imperviousness to electrolytic liquids. This integrity of the moisture barrier is necessary, since the implants are operated in the body of living beings, i.e. in an environment with electrolytes comparable to physiological saline solution.

The known method represented in FIG. 1 has the disadvantage that very small electric currents and/or changes of charge between the electrodes are detected with it only inadequately, or can be superimposed with external electromagnetic interferences. It is therefore an object of the present invention to make available a measuring method that enables a measurement as exactly as possible of electric charge that has flowed between two electrodes, in particular over relatively long and very long periods of time, for checking the imperviousness of moisture barriers. A further object of the present invention consists in making available a device that enables as exact a measurement as possible of electric charge that has flowed between two electrodes, for the purpose of checking the imperviousness of moisture barriers.

The aforementioned object is achieved by means of a device for measuring small electric charges, having a test electrode and a measuring electrode, which are each in contact with an electrolyte liquid and are connected to one another via a source of electric voltage. The test electrode is surrounded by a moisture barrier, the imperviousness of which is to be examined, and the measuring electrode includes a metal strip which is in contact with the electrolyte liquid and becomes detached from the measuring electrode and/or goes into solution in the electrolyte liquid to an extent depending on the quantity of the electrical charge-carriers exchanged between the electrodes.

According to a further aspect of the present invention, the aforementioned object is achieved by means of an electrochemical charge-measuring method for testing the imperviousness of moisture barriers, in particular for active implants, the method including at least the following steps:
a. immersing a test electrode in an electrolyte liquid, wherein the test electrode is encompassed by a moisture barrier, the imperviousness of which is to be examined;
b. immersing a measuring electrode in the electrolyte liquid, wherein the measuring electrode includes a metal strip which is in contact with the electrolyte liquid and becomes detached from the measuring electrode and/or goes into solution in the electrolyte liquid to an extent depending on the quantity of the electrical charge-carriers exchanged between the electrodes if electrolyte liquid and/or ions penetrate the moisture barrier of the test electrode;
c. connecting the test electrode and the measuring electrode to a direct current source, wherein one electrode is connected to the direct current source in such a manner that electrons migrate from the direct current source to the one electrode, and the other electrode is connected to the direct current source in such a way that electrons migrate from the other electrode to the direct current source; and
d. measuring the dissolution and/or detachment of the metal strip from the measuring electrode as a measure of the quantity of the electrical charge-carriers exchanged between the electrodes and as a measure of the imperviousness of the moisture barrier.

The measuring method according to the invention is based on a galvanic process which takes place in the measuring device according to the invention, whereby an electrochemical, integrative measuring process is implemented which permits an extremely exact determination of the electric charge that has flowed between two electrodes. With the aid of the method according to the invention, the integrity or imperviousness of insulating layers or moisture barriers for implants can be verified more exactly than hitherto. By means of the method according to the invention, the influence of electromagnetic interferences on the measurement result is reduced, as no coulometer has to be used any longer. Hence the method according to the invention is distinguished by substantial insensitivity to interspersed external electromagnetic interferences and is additionally inexpensive.

Hence, the subject-matters according to the invention make it possible—without an external measuring apparatus as in the state of the art, which measures current or voltage from outside—to perform, in accordance with the invention, corresponding measurements continuously, for example via the dissolution of gold on the measuring electrode.

Further particulars, preferred embodiments and advantages of the present invention will become apparent from the following description with reference to the appended drawings. Shown are:

FIG. 1 a schematic set-up for implementing an integrative, electrochemical charge-measuring method according to the state of the art, which has already been described above;

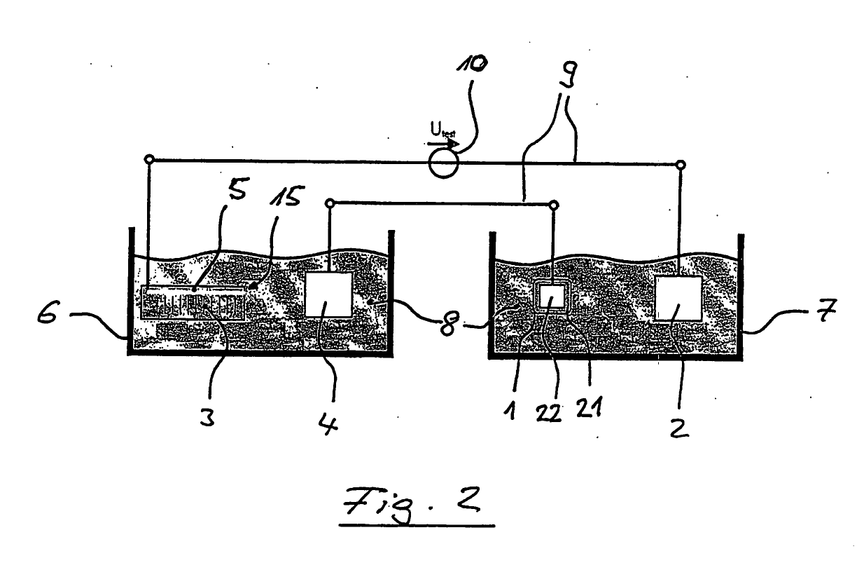

FIG. 2 the schematic representation of the measuring device according to a preferred embodiment of the present invention;

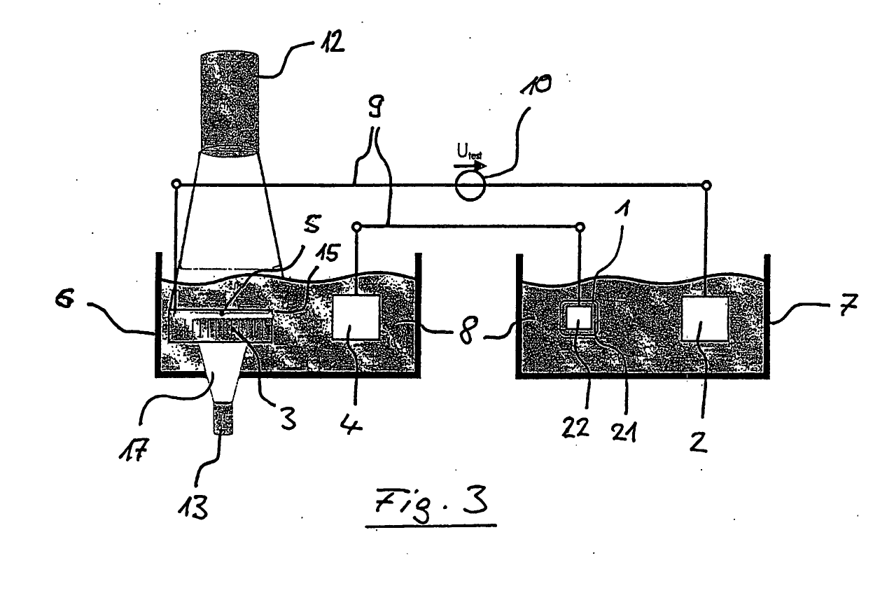

FIG. 3 the schematic representation of a measuring device according to another preferred embodiment of the present invention, equipped with a microscope;

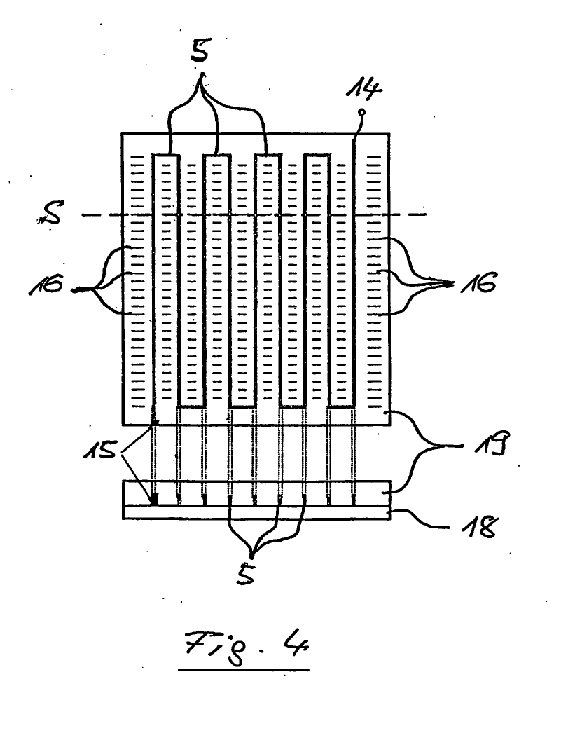

FIG. 4 the schematic representation of a measuring electrode with linearly configured metal strip and with integrated scale for use in a measuring device according to the present invention;

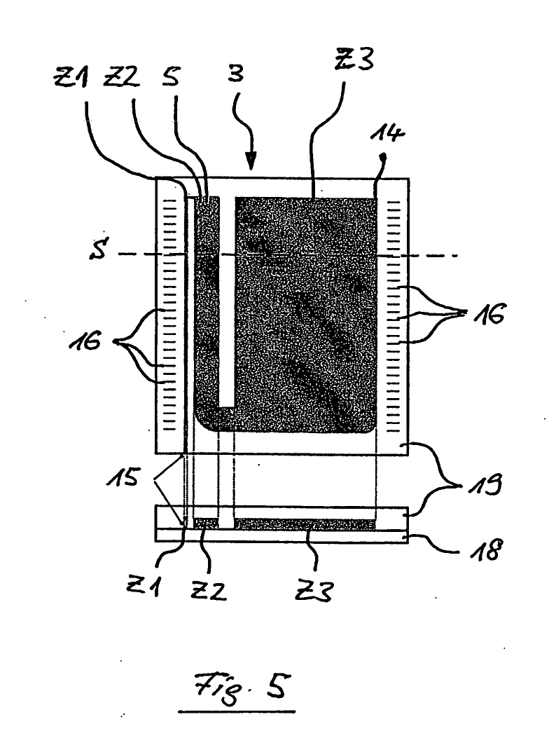

FIG. 5 the schematic representation of a measuring electrode with non-linearly configured metal strip in zones of varying widths and with integrated scale for use in a measuring device according to the present invention; and

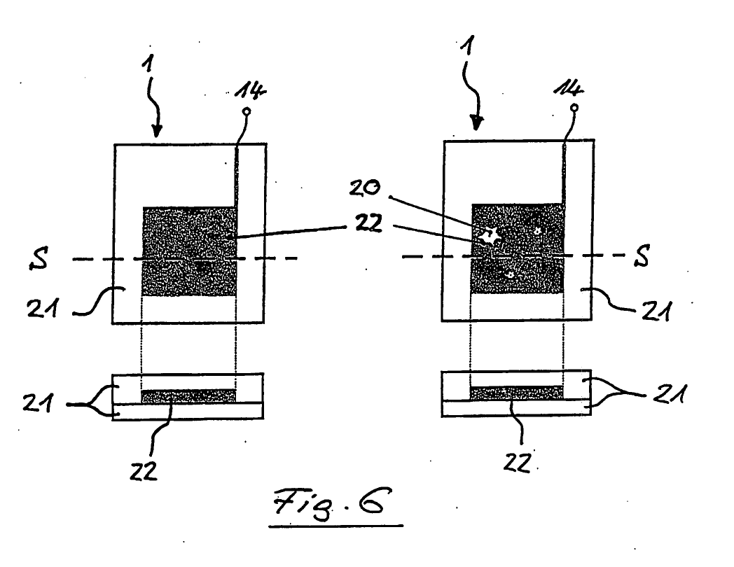

FIG. 6 the schematic representation of a test electrode with a metal core, configured as a metal surface, for use in a measuring device according to the present invention.

FIG. 2 shows the schematic representation of the measuring device according to a preferred embodiment of the present invention. In the preferred embodiment of the present invention represented in FIG. 2, the measuring device includes a first bath 6 and a second bath 7, which are each filled with electrolyte liquid 8. By way of electrolyte liquid 8, use may be made, for example, of a saline solution or other electrolytes that guarantee a high ion density with good ion mobility. The first bath 6 will subsequently be designated as the measuring cell, and the second bath 7 will subsequently be designated as the test cell.

In the second bath 7 (test cell) a first electrode or a test electrode 1 and also a second electrode 2 are immersed which in this way are each surrounded by electrolyte liquid 8. The first electrode or test electrode 1 contains a metal core 22 which is surrounded by an insulating layer or by a moisture barrier 21, the imperviousness or integrity of which is to be examined. The metal core 22 of the first electrode 1 is produced from the same metal as the second electrode 2, in order to prevent an electric voltage potential within the test cell 7 on account of differing materials between the first electrode or test electrode 1 and the second electrode 2. Platinum, for example, is suitable as material for the metal core 22 of the first electrode 1 and for the second electrode 2.

In the first bath 6 (measuring cell) a third electrode or a measuring electrode 3 and also a fourth electrode 4 are immersed which in turn are each surrounded by electrolyte liquid 8. The fourth electrode 4 preferentially exhibits a larger surface area than the measuring electrode 3, in order to keep the impedance of the arrangement sufficiently low. The measuring electrode 3 of the measuring device according to the invention includes a thin metal strip 5 which is in contact with the electrolyte liquid. The metal strip 5 is produced from gold, copper, silver, aluminium or another metal with a thickness of a few nanometres. The fourth electrode 4 is produced from the same metal as the metal strip 5 of the measuring electrode 3, in order to prevent an electric voltage potential within the measuring cell 6 by reason of differing materials between the third electrode or measuring electrode 3 and the fourth electrode 4.

The metal strip 5 of the measuring electrode 3 is surrounded by an insulator which has been produced from an electrically insulating material such as, for example, polyimide, glass, parylenes, diamond, sapphire or silicone. The third electrode or measuring electrode 3 is almost completely surrounded by the insulator in watertight manner and merely at one end of the metal strip 5 exhibits a window opening 15 (see also FIGS. 4 and 5). The window opening 15 is completely immersed in the electrolyte liquid 8 of the measuring cell 6 and hence completely surrounded by the electrolyte liquid 8. In this way, one end of the metal strip 5 of the measuring electrode 3 is openly exposed to the electrolytic bath of the measuring cell 6 and is therefore in contact with the electrolyte liquid 8. At the end of the metal strip 5 of the measuring electrode 3 that is located opposite the open side of the measuring electrode 3, the metal strip 5 is contacted via an electrical feed line 9 which is electrically insulated and also encased in liquid-tight manner and which leads out of the measuring cell 6 from the third electrode or measuring electrode 3.

In the embodiment of the measuring device according to the invention that is represented in FIG. 2, the measuring cell 6 and the test cell 7 are electrically connected to one another via a direct current voltage source 10. To this end, an electrical line 9 leads from the measuring electrode 3 to the direct current voltage source 10, and an electrical line 9 leads from the second electrode 2 to the direct current voltage source 10, whereas the first electrode 1 and the fourth electrode 4 are directly connected to one another via an electrical line 9. Via the direct current voltage source 10 an electric test direct current voltage Uₜₑₛₜ is set with a sufficiently high value which, for example, may lie within a range from 2 volts to 10 volts, in order to subject the insulation or moisture barrier 21 of the test electrode 1 that is to be checked to a loading that is realistic under operational conditions.

If an electric voltage is applied via the direct current source 10 and the moisture barrier 21 of the test electrode 1 exhibits leakages, electrolyte liquid 8 or ions can penetrate the moisture barrier 21 and reach the metal core 22 of the test electrode 1. As a result, electrical charge-carriers can be exchanged between the test electrode 1 and the measuring electrode 3 via the electrolyte liquid 8, so that current flows via the electrical connecting lines 9. The flow of current results in a degradation or dissolution of the metal strip 5 in the test electrode 3, which is expressed in a change of geometry, in particular in a change of length of the metal strip 5. In this way, the quantity of the charge-carriers that have flowed between the test electrode 1 and the measuring electrode 3 can be gauged on the basis of the change of geometry or change of length of the metal strip 5 of the test electrode 3.

The cause of this is constituted by the electrochemical processes and the transfer of electric charge during the flow of current between the electrodes 1, 2, 3, 4, as a result of which the metal of the thin metal strip 5 is successively eroded from the measuring electrode 1 in a manner proportional to the charge that has flowed, and goes into solution in the electrolyte bath 6, while deposits form on the fourth electrode 4, with corresponding exchange of electric charge. In this galvanic process, in the test cell 7 the test electrode 1 acts as anode and the second electrode 2 acts as cathode; furthermore, in this process in the measuring cell 6 the metal strip 5 of the test electrode 1 acts as sacrificial anode and the fourth electrode 4 acts as cathode. As a result, the length of the metal strip 5 of the third electrode or measuring electrode 3 is diminished, which can be measured as a change of geometry or change of length of the metal strip.

Via the direct current voltage source 10 an electric test direct current voltage Uₜₑₛₜ can be set such as is also used as operating voltage of an implant in the implanted state. In order to shorten the test-time, the test direct current voltage Uₜₑₛₜ may also be substantially higher than the normal operating voltage of an implant, in order to subject the moisture barrier 21 to be tested to an increased ion pressure, and hence to load it beyond the normal loading. Additionally or alternatively, the temperature under which the measuring method according to the invention is implemented and under which the measuring device according to the invention is operated can also be increased, by, for example, the temperature of the electrolyte bath being increased, so that an accelerated ageing of the moisture barrier 21 of the test electrode 1 is simulated.

The partitioning of the measuring device according to the invention into two electrolyte baths 6 and 7 is undertaken essentially for the purpose of compensating any possible differences of material between the metal core 22 of the test electrode 1 and the metal strip 5 of the measuring electrode 3. For if the metal core 22 of the test electrode 1 and the metal strip 5 of the measuring electrode 3 consist of differing materials, electric voltage potentials between the electrodes 1, 3 may occur, which may impair the result of measurement. By virtue of the partitioning of the measuring device into two electrolyte baths 6 and 7 in the manner described above, differing materials can also be used for the metal core 22 of the test electrode 1 and for the metal strip 5 of the measuring electrode 3, without the result of measurement being impaired by an electric voltage potential by reason of differing materials between the metal core 22 of the test electrode 1 and the metal strip 5 of the measuring electrode 3.

It is, however, also possible to operate the measuring method according to the invention in a measuring device that includes only one electrolyte bath in which the test electrode 1 with the moisture barrier 21 to be tested and the measuring electrode 3 with the metal strip 5 are each immersed. To this end, the metal core 22 of the test electrode 1 and the metal strip 5 of the measuring electrode 3 should have been produced from the same material, in order to prevent electric voltage potentials between the electrodes 1, 3 by reason of differing materials. In this connection, the test electrode 1 and the measuring electrode 3 are again coupled with one another via a direct current voltage source 10; but in this case neither a second nor a fourth electrode is required. Also with such a structure of the measuring device according to the invention having only one electrolyte bath, an exchange of electrical charge-carriers between the electrodes 1, 3 comes about only when an electric voltage is applied via the direct current voltage source 10 and the moisture barrier 21 of the test electrode 1 exhibits defects or leakages and can be penetrated by electrolyte liquid or ions. In this case, the quantity of the charge-carriers exchanged between the test electrode 1 and the measuring electrode 3 can again be gauged on the basis of the change of geometry or change of length of the metal strip 5 of the measuring electrode 3.

In FIG. 3 a measuring device according to another preferred embodiment of the present invention is represented schematically, wherein the structure of the measuring device essentially corresponds to the structure of the embodiment of the measuring device represented in FIG. 2. In the case of the structure of the measuring device represented in FIG. 3, the measuring electrode 3 in the electrolyte bath of the measuring cell 6 is placed in such a way that the change of length of the metal strip 5 of the measuring electrode 1 can also be observed during the measuring procedure. Beneath the electrolyte bath 6 there is arranged in the region of the measuring electrode 3 a light-source 13 which projects a light cone 17 onto the measuring electrode 3. Above the electrolyte bath 6 there is arranged in the region of the measuring electrode 3 a microscope 12 by which the metal strip 5 of the measuring electrode 3 can be inspected. To this end, the trough of the electrolyte bath 6 preferentially consists of a transparent material or exhibits in the region of the measuring electrode 3 a window made of transparent material, in order that the light of the light-source 13 is able to illuminate the measuring electrode 3 and an observation of the measuring electrode 3 in the electrolyte bath 6 is possible via the microscope 12. The remaining structure of the measuring device according to the invention corresponds to the structure represented in FIG. 2, for which reason reference is made to the explanatory remarks relating to FIG. 2 for the purpose of further description.

As described above, the extent of the change of geometry or change of length of the thin metal strip 5 is a measure of the electric current that has flowed between the electrodes 1, 2, 3, 4, which can be measured more exactly by means of the present invention even if only small amounts of charge are being exchanged between the electrodes. The equipping of the measuring device according to the invention with a microscope 12 further permits the implementation of a measurement over a longer period of time under continuous observation, without the measuring electrode 3 having to be removed from the electrolyte bath 6, for example for the purpose of recording intermediate results. With the aid of this set-up, the change of geometry or change of length of the metal strip 5 of the measuring electrode 3 can be registered accurately by the microscope 12 also during the test method.

FIG. 4 shows the schematic representation of a preferred embodiment of the measuring electrode 3 for use in a measuring device according to the present invention. The upper part of FIG. 4 shows a top view of the measuring electrode 3, whereas the lower part shows a cross-sectional view along the dashed section line S in the upper part of FIG. 4. In the embodiment of the measuring electrode 3 represented in FIG. 4, the metal strip 5 is formed in serpentine lines over the surface of the measuring electrode 3, in order in this way to accommodate as great a length as possible of the metal strip 5 on the surface of the measuring electrode 3. In this connection the cross-section of the metal strip 5 is linearly configured—that is to say, its width and height over the contour of the metal strip 5 remain substantially unchanged, as can be discerned in the cross-sectional view in the lower part of FIG. 4. Furthermore, the measuring electrode 3 is provided with integrated scales 16, in order to facilitate the gauging of the changes of length of the metal strip 5.

The measuring electrode 3 is surrounded by an insulating carrier substrate 18 and an insulator 19 in almost completely watertight manner and exhibits merely at one place a window opening 15 at which one end of the metal strip 5 is located. In this way, in the immersed state the end face of the metal strip 5 of the measuring electrode 3 is openly exposed to the electrolytic bath of the measuring cell 6 and is therefore in contact with the electrolyte liquid 8. The window opening 15 of the third electrode or measuring electrode 3 is completely immersed in the electrolyte liquid 8 of the measuring cell 6 and hence completely surrounded by the electrolyte 8. At its other end, the metal strip 5 of the measuring electrode 3 is provided with an electrical terminal 14 which, for example, is attached to the metal strip 5 by bonding or by using conducting adhesives. The electrical terminal 14 is contacted by an electrical feed line 9 which is electrically insulated and also encased in watertight manner and leads out of the measuring cell 6 from the third electrode or measuring electrode 3, as already described with reference to FIG. 2.

Production of the metal strip 5 of the measuring electrode 3, which is arranged between the insulating carrier substrate 18 and the insulator 19 or between two insulators 19, can be effected, for example, in such a way that the insulator 19 (for example, made of polyimide) is applied onto the carrier substrate 18 by so-called spin coating and is then brought into a stable shape, for example by thermal treatment. Subsequently the thin metal strip 5 made of the desired grade of metal is applied onto the carrier layer 18, for example with the aid of a sputtering process using a mask. Alternatively, the insulator layer may also serve directly as carrier substrate 18, for example in the case where use is made of glass or other materials by way of insulator. Onto the carrier substrate 18 coated with the thin metal strip 5, or on the insulator 19, a further insulator layer 19 is subsequently applied. This is effected by, for example, polyimide being applied by so-called spin coating or by parylenes being applied by pyrolytic polymerisation on the thin metal strip 5.

Meanwhile, very thin layers of metal, with a thickness of a few nanometres and with very small structural width of a few micrometers, can be produced. As a result, a flow of electric current, even with very small amounts of charge that are being exchanged between the test electrode 1 and the measuring electrode 3, can cause an optically visible change of geometry or change of length of the thin metal strip 5 of the measuring electrode 3.

FIG. 5 shows the schematic representation of another preferred embodiment of the measuring electrode 3 for use in a measuring device according to the present invention. The upper part of FIG. 5 shows a top view of the measuring electrode 3, whereas the lower part shows a cross-sectional view along the dashed section line S in the upper part of FIG. 5. In the embodiment of the measuring electrode 3 represented in FIG. 5, the metal strip 5 is subdivided into several discrete zones Z1, Z2 and Z3, in each of which the metal strip 5 exhibits a different cross-section. This variation in the cross-section of the metal strip 5 is achieved in each case by means of differing widths of the metal strip 5 in the zones Z1, Z2, Z3, as can be gathered from the lower part of FIG. 5.

Variation of the cross-section of the metal strip 5 can be effected both in linear manner and in non-linear manner over a part or over the entire length of the metal strip 5. A linear change of the cross-section of the metal strip 5 can be achieved, for example, by the sequence of the zones Z1, Z2, Z3 of the metal strip of 5 exhibiting monotonically increasing cross-sections. For the purpose of varying the cross-section of the metal strip 5 of the measuring electrode 3, the width and the height of the metal strip 5 or just the width or just the height of the metal strip 5 can be varied. In the embodiment represented in FIG. 5, the metal strip 5 of the measuring electrode 3 is subdivided into three zones Z1 to Z3, the widths B1, B2, and B3 of the metal strip 5 in the zones Z1 to Z3 exhibiting, for example, a ratio of B1=1, B2=10, B3=100 relative to one another. The window opening 15 of the measuring electrode 3, via which the metal strip 5 is in contact with the electrolyte liquid 8, opens at the first zone Z1 with the smallest width or with the smallest cross-section of the metal strip 5. The first zone Z1 is adjoined by the second zone Z2 of the metal strip 5 with a medium width or with a medium cross-section, which in the continuation merges with the third zone Z3 of the metal strip with the largest width or with the largest cross-section of the metal strip 5.

If the insulating layer or the moisture barrier 21 to be checked of the test electrode 1 exhibits leakages or other defects which in test operation result in a penetration of the moisture barrier 21 and hence in a direct contact of the metal core 22 of the test electrode 1 with the electrolyte liquid 8, the electrochemical processes described above begin, which bring about the dissolution of the thin metal strip 5 of the measuring electrode 3. Since the transfer of electric charges between the electrodes 1, 3 and the dissolution of the metal strip 5 of the measuring electrode 3 take place in directly proportional manner, with the same exchange of charge the change of length of the metal strip 5 of the measuring electrode 3 turns out to be correspondingly more distinct if the metal strip 5 of the measuring electrode 3 exhibits a smaller width or a smaller cross-section.

By virtue of the gradation of the zones Z1 to Z3 with, in each case, increasing widths or cross-sections of the metal strip 5, a test electrode 1 is consequently created that is able to detect and measure both small currents of charge that have flowed—by reason of small defects in the moisture barrier 21 to be checked of the test electrode 1—and large currents of charge that have flowed—in the case of relatively large leakages of the moisture barrier 21 to be tested of the test electrode 1. In the case of small leakages of the moisture barrier 21 to be checked on the test electrode 1, only a small electric current arises between the test electrode 1 and the measuring electrode 3, resulting firstly only in dissolutions of the metal strip 5 of the measuring electrode 3 in the first zone Z1. Since the width or the cross-section of the metal strip 5 of the measuring electrode 3 in the first zone Z1 exhibits only a small width, the degradation of the metal strip 5 by reason of the electrochemical processes in relation to the other zones Z2 and Z3 results in a more rapid change of length of the metal strip 5. By virtue of such a variation, in segments, of the cross-section of the metal strip 5 of the measuring electrode 3, measuring-periods with correspondingly higher or lower measuring accuracy can therefore be established.

In the case of relatively small defects in the moisture barrier 21 to be checked on the test electrode 1, only a small electric current arises between the electrodes 1, 3, for which reason the dissolution of the metal strip 5 of the measuring electrode 3 barely goes beyond the first zone Z1. If, by reason of larger defects in the moisture barrier 21 to be checked, a larger electric current flows between the electrodes 1, 2, the first zone Z1 of the metal strip 5 of the measuring electrode 3 dissolves rapidly, and the shortening of the length of the metal strip 5 reaches the second zone Z2. In the case of still larger defects in the moisture barrier 21 to be tested, still larger currents accordingly arise between the electrodes 1, 3, and the dissolution or shortening of the length of the metal strip 5 of the measuring electrode 3 extends as far as the third zone Z3.

In this connection, it is of course to be taken into account that a short, medium or long measuring-time, with exchange of electric charges between the electrodes 1, 3 assumed constant, results in correspondingly small, medium or greater dissolutions or change of length of the metal strip 5 of the measuring electrode 3. Thus, even in the case of relatively small defects in the moisture barrier 21 to be checked on the test electrode 1, over very long measuring-times the dissolution of the metal strip 5 of the measuring electrode 3 may accordingly extend into the second or third zone, Z2 and Z3, of the metal strip 5.

According to another preferred embodiment of the measuring electrode 3, instead of the division of the metal strip 5 of the measuring electrode 3 into discrete zones Z1 Z2, Z3 a cross-section of the metal strip 5 increasing monotonically, linearly or non-linearly from its free end at the window opening 15 may be provided. Similarly, widths and/or thicknesses of the metal strip 5 of the measuring electrode 3 increasing linearly or non-linearly from its free end may be provided. A non-linear increase in the width and/or thickness or cross-section of the metal strip 5 of the measuring electrode 3 can, for example, be effected quadratically, cubically, exponentially or in accordance with other functions. Instead of a monotonically, linearly or non-linearly increasing cross-section of the metal strip 5 of the measuring electrode 3, zones of widths narrowing again or with cross-section decreasing again may also be provided. As the electrochemical processes described above bring about greater changes of length of the metal strip 5 in the case of smaller cross-sections of the metal strip 5, with the aid of widths and/or thicknesses that narrow again, or a cross-section of the metal strip 5 of the measuring electrode 3 that decreases again, a more precise measurement can again be performed at particular times during the measuring procedure.

According to another preferred embodiment of the measuring procedure according to the present invention, the measuring electrode 3 may be so designed that it is employed only for a fixed period of time and is then replaced by a new measuring electrode 3 and archived. During the measurement or after completion of the entire measurement—which, for example, may amount to a few minutes, hours, days, weeks, months or years—all the archived measuring electrodes 3 as well as the measuring electrode 3 still in use are evaluated, and the total quantity of charge or partial quantity of charge of the charge-carriers that have flowed between the electrodes is ascertained therefrom.

FIG. 6 shows the schematic representation of a test electrode 1 with a metal core 22, formed as a metal surface, for use in a measuring device according to the present invention. The left-hand part of FIG. 6 shows a schematic view of the test electrode 1 before being subjected to a test method, whereas the right-hand part shows a schematic view of the test electrode 1 after being subjected to the test method. The left-hand and right-hand parts of FIG. 6 are each subdivided into an upper and a lower part, the upper part representing in each case a top view of the measuring electrode 3, whereas the lower part represents a cross-sectional view along the dashed section line S in the upper part of FIG. 6.

This embodiment of the test electrode 1 serves for examining moisture barriers 21 that are to be employed as insulating layers for implants. The metal surface of the metal core 22 of the test electrode 1 is surrounded by the insulating layers or moisture barriers 21 to be tested, the imperviousness or integrity of which is to be tested. The metal core 22, formed as a metal surface, of the test electrode 1 is provided with an electrical terminal 14, to which an electrical feed line 9 for applying a test voltage Uₜₑₛₜ can be connected. The dimensions of the metal core 22, formed into a metal surface, of the test electrode 1 may correspond to the surface area of the planned implant or may be larger than the surface area of the implant. By virtue of larger dimensions of the test electrode 1, the surfaces of the moisture barrier 21 to be checked are enlarged, and the probability of defects 20 in the moisture barrier 21—such as, for example, perforations (pinholes) in the region of the test surface—is increased. In this manner a more precise statement can be made about the number of defects 20 in the insulating layers or moisture barriers 21 per surface measure.

In the embodiment represented in FIG. 6, the test surface of the test electrode 1 is produced from a thin metal layer which is arranged between two of the insulating layers or moisture barriers 21. For the purpose of producing such a test electrode 1, use may be made of a method that is similar or identical to that for producing the measuring electrode 3. The thickness of this thin metal layer may, as in the case of the metal strip 5, lie within the range of a few nanometres. If the metal layer is constructed very thinly, the defects 20 in the insulating layer or moisture barrier 21 result in the dissolution of the metal layer 22 in the neighbourhood thereof, so that the metal layer 22 of the test electrode 1 becomes transparent at these places, as can be discerned in the right-hand part of FIG. 6. These transparent places 20 can be detected well, for example, with the aid of a transmitted-light microscope. The metal core 22, formed into a thin metal layer, of the test electrode 1 consequently serves in this embodiment as a means for making defects in the moisture barrier 21 visible. Serial measurements or repeated measurements with a test electrode 1 or serial measurements with the aid of the same measuring electrode 3 can also be carried out.

### LIST OF REFERENCE SYMBOLS

1 first electrode or test electrode with moisture barrier to be checked

2 second electrode or cathode

3 third electrode or measuring electrode

4 fourth electrode or cathode

5 metal strip of the measuring electrode

6 first electrolyte bath or measuring cell

7 second electrolyte bath or test cell

8 electrolyte liquid

9 electrical leads

10 direct current source

11 charge-measuring instrument or coulometer

12 microscope

13 light-source

14 electrical connection-point of the measuring electrode

15 opening for contact between electrolyte liquid and metal strip

16 scale on the measuring electrode

17 light cone of the light-source

18 carrier substrate of the measuring electrode

19 insulator layer of the measuring electrode

20 defects (pinholes) in the metal strip of the measuring electrode

21 moisture barrier or insulating layer around the first electrode

22 metal core

S section line

Z1 first zone of the metal strip of the measuring electrode

Z2 second zone of the metal strip of the measuring electrode

Z3 third zone of the metal strip of the measuring electrode

1. Device for measuring small electric charges, having a test electrode and a measuring electrode, which are each in contact with an electrolyte liquid and are connected to one another via an electrical voltage-source, wherein the test electrode is surrounded by a moisture barrier, the imperviousness of which is to be examined, characterised in that the measuring electrode includes a metal strip which is in contact with the electrolyte liquid and becomes detached from the measuring electrode and/or goes into solution in the electrolyte liquid to an extent depending on the quantity of the electrical charge-carriers exchanged between the electrodes.

2. Device according to claim 1, wherein the detachment and/or dissolution of the metal strip of the measuring electrode causes a change of geometry and/or a change of length of the metal strip that corresponds to the quantity of the charge-carriers exchanged between the test electrode and the measuring electrode, and thus represents a measure of the imperviousness of the moisture barrier.

3. Device according to claim 1, wherein the metal strip of the measuring electrode is almost completely surrounded by an insulator which is produced from an electrically insulating material.

4. Device according to claim 3, wherein the insulator that surrounds the metal strip of the measuring electrode comprises an opening via which one end of the metal strip is in contact with the electrolyte liquid.

5. Device according to claim 1, wherein the metal strip of the measuring electrode is contactable via an electrical terminal which is arranged at the end of the metal strip that is situated opposite the end of the metal strip in contact with the electrolyte liquid.

6. Device according to claim 1, wherein the metal strip of the measuring electrode is formed in serpentine lines over the surface of the measuring electrode.

7. Device according to claim 1, wherein the metal strip of the measuring electrode is subdivided into a number of discrete zones in which the metal strip comprises a different cross-section.

8. Device according to claim 1, wherein the metal strip of the measuring electrode is subdivided into a number of discrete zones in which the metal strip comprises differing thicknesses and/or differing widths.

9. Device according to claim 1, wherein the cross-section of the metal strip of the measuring electrode increases over the length of the metal strip at least in segments in accordance with a monotonic, linear and/or non-linear relationship.

10. Device according to claim 1, wherein the cross-section of the metal strip of the measuring electrode decreases over the length of the metal strip at least in segments in accordance with a monotonic, linear and/or non-linear relationship.

11. Device according to claim 1, wherein the metal strip of the measuring electrode is arranged between two insulating layers.

12. Device according to claim 11, wherein the insulating layers or the insulator that surrounds the metal strip of the measuring electrode are produced from polyimide, glass, parylenes, diamond, sapphire or silicone.

13. Device according to claim 1, wherein the metal strip of the measuring electrode comprises a thickness of a few nanometres.

14. Device according to claim 1, wherein at least one integrated scale is formed on the measuring electrode, in order to facilitate the gauging of changes of length of the metal strip.

15. Device according to claim 1, wherein the test electrode comprises a metal core which is surrounded by the moisture barrier to be checked.

16. Device according to claim 15, wherein the metal core of the test electrode is produced from the same metal as the metal strip of the measuring electrode.

17. Device according to claim 1, wherein a first electrolyte-liquid bath and a second electrolyte-liquid bath are provided,
wherein a test electrode as well as a second electrode are immersed in the second electrolyte-liquid bath, and a measuring electrode as well as a fourth electrode are immersed in the first electrolyte-liquid bath, and
wherein the test electrode and the fourth electrode are directly coupled with one another, and the measuring electrode and the second electrode are coupled with one another via the direct current voltage source.

18. Device according to claim 17, wherein the test electrode and the measuring electrode act as anode, and the second electrode and the fourth electrode act as cathode.

19. Device according to claim 17, wherein the fourth electrode is produced from the same metal as the metal strip of the measuring electrode.

20. Device according to claim 1, wherein the metal strip of the measuring electrode is manufactured from gold, copper, silver or aluminium.

21. Device according to claim 15, wherein the metal core of the test electrode is manufactured from platinum.

22. Device according to claim 17 further comprising electrical leads, wherein the electrical leads for electrical coupling of the electrodes are each electrically insulated and encased in liquid-tight manner.

23. Device according to claim 17, wherein the metal strip of the measuring electrode is arranged between two insulator layers which are each produced from polyimide, glass, parylenes, diamond, sapphire, silicone or another electrically insulating material.

24. Device according to claim 1, wherein the metal strip of the measuring electrode is almost completely encompassed by the moisture barrier to be checked, and the moisture barrier comprises an opening for the contact between the electrolyte liquid and the metal strip.

25. Device according to claim 1, wherein the test electrode comprises a metal core, formed as a metal surface, which is surrounded by insulating layers to be checked or by a moisture barrier to be checked.

26. Device according to claim 25, wherein defects in the insulating layers and/or in the moisture barrier in the course of test operation result in the dissolution of the metal layer in the test electrode and generate transparent places.

27. Device according to claim 15, wherein the metal core of the test electrode is manufactured from platinum, gold, copper, silver or aluminium and with a thickness of a few nanometres.

28. Device according to claim 1, wherein in the region of the measuring electrode a microscope is provided by which the metal strip of the measuring electrode can be observed.

29. Device according to claim 1, wherein in the region of the measuring electrode a light-source is provided which illuminates the measuring electrode.

30. Device according to claim 17, wherein a trough of the electrolyte bath consists of a transparent material or comprises a window made of transparent material in the region of the measuring electrode.

31. Method for testing the imperviousness of moisture barriers for implants by means of an electrochemical charge-measuring process including at least the following steps:
a. immersing a test electrode in an electrolyte liquid, wherein the test electrode is surrounded by a moisture barrier, the imperviousness of which is to be examined;
b. immersing a measuring electrode in the electrolyte liquid, wherein the measuring electrode includes a metal strip which is in contact with the electrolyte liquid and becomes detached from the measuring electrode and/or goes into solution in the electrolyte liquid to an extent depending on the quantity of the electrical charge-carriers exchanged between the electrodes if electrolyte liquid and/or ions penetrate the moisture barrier of the test electrode;
c. connecting the test electrode and the measuring electrode to a direct current voltage source, wherein one electrode is connected to the direct current voltage source in such a manner that electrons migrate from the direct current voltage source to the one electrode, and the other electrode is connected to the direct current voltage source in such a way that electrons migrate from the other electrode to the direct current voltage source; and
d. measuring the dissolution and/or detachment of the metal strip from the measuring electrode as a measure of the quantity of the electrical charge-carriers exchanged between the electrodes and as a measure of the imperviousness of the moisture barrier.

32. Method according to claim 31, including the following steps:
a. immersing a test electrode and also a second electrode in a second electrolyte-liquid bath, wherein the test electrode is surrounded by a moisture barrier, the imperviousness of which is to be examined; and
b. immersing a measuring electrode and also a fourth electrode in a first electrolyte-liquid bath, wherein the test electrode and the fourth electrode are directly coupled with one another, and the measuring electrode and the second electrode are coupled with one another via the direct current voltage source.

33. Method according to claim 31, wherein via the direct current voltage source a test direct current voltage (Utest) is set which corresponds roughly to the operating voltage of an implant in the implanted state.

34. Method according to claim 31, wherein via the direct current voltage source a test direct current voltage (Utest) is set that is higher than the operating voltage of an implant in the implanted state, so that the moisture barrier to be tested is subjected to an increased ion pressure and is loaded beyond a normal loading.

35. Method according to claim 31, wherein the temperature of the electrolyte liquid under which the measuring method according to the invention is implemented is increased, in order to simulate an accelerated ageing of the moisture barrier to be tested.
